(19) United States
(12) Patent Application Publication
(10) Pub. No.: US 2004/0036301 A1
(43) Pub. Date: Feb. 26, 2004

(54) Portable latches

(76) Inventor: Chih-Yu Hsia, Arcadia, CA (US)

Correspondence Address: Chih-Yu Hsia, 301 Warren Way, Arcadia, CA, 91007, US

(21) Appl. No.: 10/226,618

(22) Filed: Aug. 23, 2002

(51) Int. Cl. E05C 19/18

(52) U.S. Cl. 292/288

(57) ABSTRACT

The first variation of an apparatus which consists of a plate, which can work with a bolt hole of a door jamb, and a movable part, which can engage with the plate, to create a rigid structure; the second variation of the apparatus which consists of a “U”-shaped object, which can work with the doorknob of an existing door, and a channel-liked object, which can engage with the “U”-shaped object to create a rigid structure; the third variation of the apparatus which consists of a first object, which can work with the doorknobs of the existing double swing doors, and another object, which can work with the doorknobs of the existing double swing doors and which can engage with the first object to form a rigid structure.

### BACKGROUND OF THE INVENTION

1. Field of the Invention

This invention relates to door latches and particularly to portable door latches which components can engage together to form relatively rigid frames that latch doors in a closed position.

2. Descriptions of the Prior Arts

No prior art related to portable door latches was found.

### SUMMARY OF THE INVENTION

A positively locked door which can only be opened from inside will give a traveler secured feeling when he/she is staying in a rented room. The portable latches that can be carried, installed and removed by a traveler for a rented room are thus sought.

An invented portable latch can work with the existing accessories of a door to create a rigid structure to keep the door locked. One object of this invention is to provide means to positively lock a door which swings open inside. The other object of this invention is to create means to positively lock a door which swings open outside. The third object of this invention is to provide means to positively lock a double swing door that swings open either inside or outside

These and other objects and advantages of the invention, as well as the details of an illustrative embodiment, will be more fully understood from the following specifications and drawings, in which:

### DRAWING DESCRIPTION

FIG. 1 is an isometric view of the components of the first sub-variation of the first variation of the invented device

FIG. 2 is an isometric view of the device shown in FIG. 1

FIG. 3 is an isometric view that illustrates the use of the device shown in FIG. 1.

FIG. 4 is an isometric view of the components of the second sub-variation of the first variation of the invented device

FIG. 5 is an isometric view that illustrates the use of the device shown in FIG. 4.

FIG. 6 is an isometric view of the components of the third sub-variation of the first variation of the invented device.

FIG. 7 is an isometric view that illustrates the use of the device shown in FIG. 6.

FIG. 8 is a disassembled isometric view of the components of the fourth sub-variation of the first variation of the invented device.

FIGS. 9 and 10 are isometric views of the fourth sub-variation of the first variation of the invented device shown in FIG. 8. FIG. 9 and FIG. 10 show the components of the same device are in different positions.

FIG. 11 is an isometric view that illustrates the use of the device shown in FIGS. 8, 9 or 10.

FIG. 12 is an isometric view of the components of the second variation of the invented device

FIG. 13 is an isometric view that illustrates the use of the device shown in FIG. 12.

FIG. 14 is an isometric view of variations of the components of the second variation of the invented device.

FIG. 15 is an isometric view of the components of the third variation of the invented device.

FIG. 16 is an isometric view that illustrates the use of the device shown in FIG. 15.

FIGS. 17 and 18 are isometric views of variations of the components of the third variation of the invented device.

FIG. 19 is an isometric view of a portion of a tension plate which has a bent plate as a bolt hole head.

### GENERAL DESCRIPTION

Three major variations of the invented device are introduced herein in these specifications. The first variation is for the doors open inwards to the room. The second variation is for the doors open outwards away from the room. The third variation is for the double swing doors. There are sub-variations for each of the variations

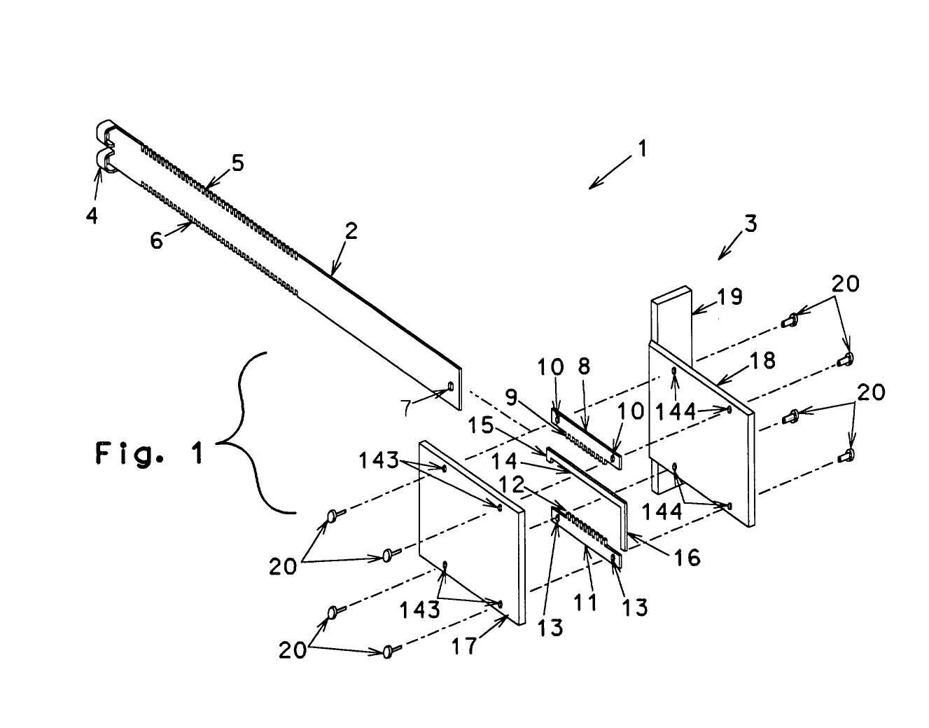

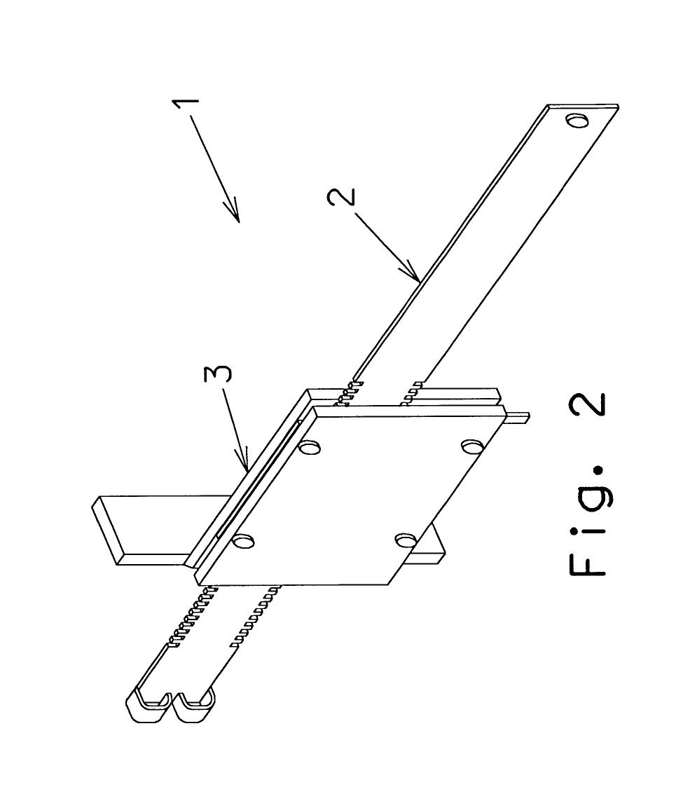

Referring to FIGS. 1 and 2, the first sub-variation of the first variation of the invented portable latches 1 consists of a tension plate 2 and a travelling part 3.

The tension plate is an elongated plate with a bolt hole head 4 on one end; a slide-off stopper 7 on the other end, many top tension teeth 5 on one edge, and many bottom tension teeth 6 on the other edge. The bolt hole head can be seen as a thickened portion of the tension plate and can be made of bent-over stripes of the same material of the tension plate. The slide-off stopper can be a bolt, a rod, a rivet, an extruding area, an enlarged portion of the tension plate, or a screw which creates a raised area above the surface of the tension plate. The top tension teeth and the bottom tension teeth are teeth or keys. The tension plate is thin enough to be able to be put in the slot between the door jamb and the door. The tension plate is long enough such that the travelling part will not block the open or closing of the door under necessary condition when the invented device is in use.

The travelling part 3 consists of a left plate 17, a upper traveling teeth plate 8, a engage limit 14, a lower travelling teeth plate 11, a right plate 18, and many fastening means 20. The upper traveling teeth plate is an elongated plate with upper traveling teeth 9 on one edge and fastening holes 10 on both ends. The lower traveling teeth plate is an elongated plate with lower traveling teeth 12 on one edge and fastening holes 13 on both ends. The upper traveling teeth and the lower traveling teeth are keys which can engage with the top tension teeth 5 and the lower tension teeth 6 of the tension plate 2, respectively. The engage limit is a “U”-shaped stripe of material with a shorter leg, the front limit 15, on one side and a longer leg, the rear limit 16, on the other side. The distance between the from limit and the rear limit is larger than the length of the upper travelling teeth plate and lower travelling teeth plate so that the engage limit can rest on either of the teeth of the upper travelling teeth plate or the lower travelling teeth plate. The left plate is a plate with many fastening holes 143 The right plate is a plate with many fastening holes 144 and with a doorstopper plate 19. The door stopper plate is a plate bent in sharp angle with the rest portion of the right plate The fastening means are bolts and nuts, rivets or other mean which can fasten things together. All of the aforementioned fastening holes are holes that allow the fastening means to penetrate through.

In the construction of the traveling plate, the upper travelling teeth plate 8 and the lower travelling teeth plate 11 will be sandwiched by the left plate 17 and the right plate 18. The upper travelling teeth plate will be on one edge of the combined right plate and the left plate. The lower travelling teeth plate will be on the other edge of the right plate and the left plate. The teeth of the upper travelling teeth plate and the lower travelling teeth plate will face toward each other's The fastening means will penetrate the fastening holes and fasten the four plates together.

In the construction of the first sub-variation of the first variation of the invented device, the slide-off stopper 7 of the tension plate 2 is either removed, not existing, or bypassed. Then the tension plate will be inserted into the gap formed between the left plat 17, the upper travelling teeth plat 8, the lower travelling teeth plate 11, and the right plate 18 of the travelling part 3. Then the slide-off stopper 7 will be installed, placed, or observed on the tension plate 2. The function of the slide-off stopper is to prevent the tension plate being slide off from the travelling part. The engage limit will be inserted into either slots formed between the tension plate and the lower travelling teeth plate or between the tension plate the upper travelling teeth plate. The height of the tension plate is smaller than the height of the slot between the engage limit and the upper travelling teeth plate or the lower travelling teeth plate The travelling part can therefore slide freely on the tension plate

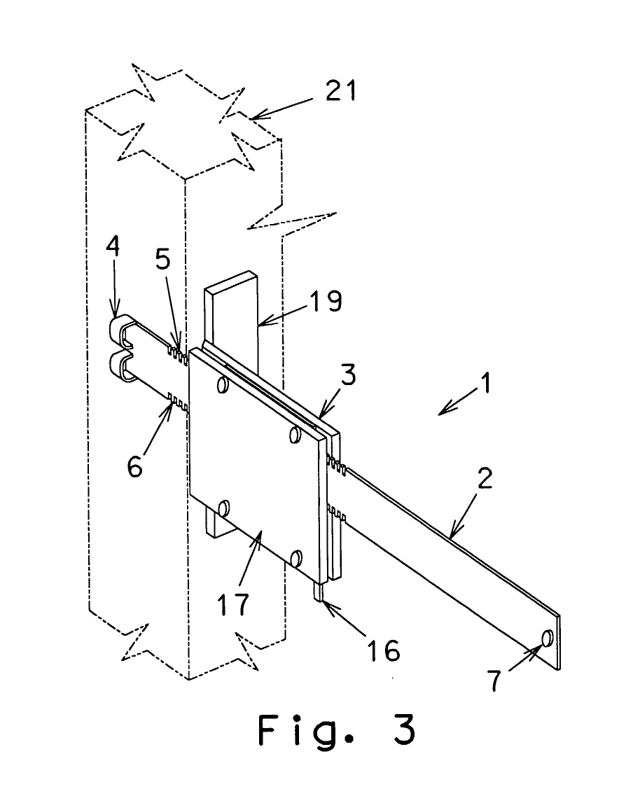

Referring to FIG. 3, when using the first sub-variation of the first variation of the invented device 1 for the door 21 which opens inwardly with the bolt hole (not shown) on the left jamb, the travelling part 3 will be put near the slide-off stopper 7 of the tension plate 2 first. The user needs to ensure that the lower travelling teeth plate is between the front limit and the rear limit 16 of the engage limit. If the engage limit is not in the correct position, the user needs just to lift up the engage limit by holding and lifting the rear limit 16; slide out the engage limit; turn the engage limit upside down; and re-insert the engage limit back into the slot between the lower travelling teeth plate and the tension plate. Then the user opens the door and puts the bolt hole head 4 into the bolt hole Then the user closes the door. The tension plate will stay in the slot between the door and the left jamb. As discussed earlier, the tension plate is long enough such that the door stopper plate of the travelling part will not block the closing door. Then the user lifts up slightly the traveling part and slides it forward until the door stopper plate 19 touches the closed door 21. Then the user slides the travelling part backwards and forwards slightly to hunt for a position so that the upper travelling teeth of the upper travelling teeth plate can engage with the top tension teeth 5 of the tension plate. Then the travelling part will be pushed downwards to secure a firm engagements between the top tension teeth and the upper travelling teeth. When the teeth are locked, the relative locations of the traveling part and the tension plate are fixed. Because the location of the bolt hole head is fixed in the bolt hole, the location of the door stopper plate is fixed. This in turn will limit the door in its closed position. Then the invented device will securely lock the door.

To unlock the door, the user lifts up the travelling part to disengage the teeth of the tension plate and the travelling part Then the user slides the travelling part back to the slide-off stopper. The user then can open the door. The user then removes the device from the doorjamb and the door can be used as it is intended to. The functions of the engage limit is to prevent the lower travelling teeth to engage with the lower tension teeth when the travelling part is lift upwards. The engage limit also provides a smooth surface for the travelling part to slide on.

When using the first sub-variation of the first variation of the invented device for the door which opens inwardly with the bolt hole on the right jamb, the user firstly ensure that the upper travelling teeth plate is between the front limit and the rear limit of the engage limit. If the position of the engage limit is not correct, the position can be altered in the same way described previously. Then the invented device can be used in a similar way described in the last two paragraphs.

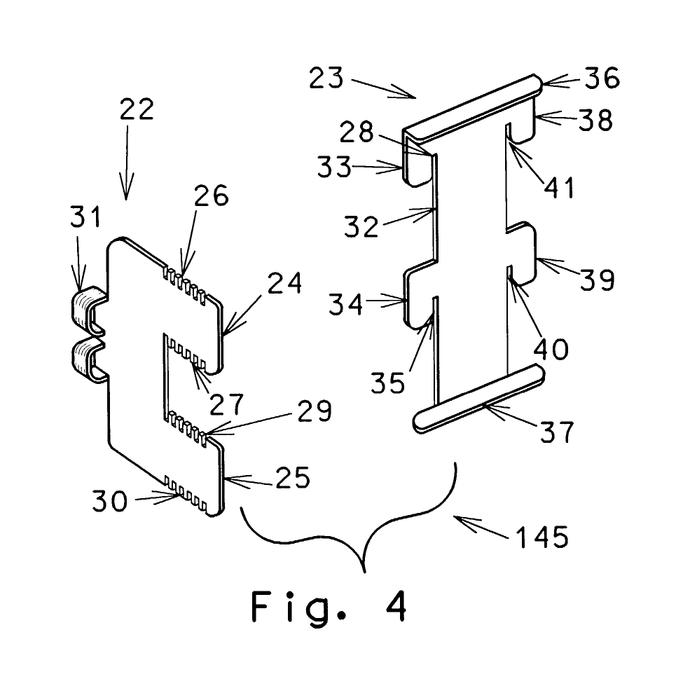

Referring to FIG. 4, the second sub-variation of the first variation of the invented portable latch 145 consists of a tension plate 22 and a door stopper plate 23.

The tension plate is a plate with a bolt hole head 31 on one edge and two teeth plates, the upper teeth plate 24 and the lower teeth plate 25, on the other edge. The bolt hole head can be seen as a thickened portion of the tension plate and can be made of bent-over stripes of the same material of the tension plate. The upper teeth plate is plate with the upper teeth 26 on its upper edge and the lower teeth 27 on its lower edge. Similar, the lower teeth plate is a plate with the upper teeth 29 on its upper edge and the lower teeth 30 on its lower edge The upper teeth and the lower teeth are keys. The tension plate is thin enough to be able to be put in the slot between the door jamb and the door The length of the tension plate is more than the thickness of a door.

The door stopper plate is a plate which consists of a main plate 32, a top bend plate 36, a bottom bend plate 37, a upper teeth left plate 33, a lower teeth left plate 34, a upper teeth right plate 38, and a lower teeth right plate 39. The top bend plate and the bottom bend plate are on opposite edges of the main plate. The top bend plate and the bottom bend plate each bends to the same side of the main plate

The upper teeth left plate, the lower teeth left plate, the lower teeth right plate, and the upper teeth right plate are short plates. A teeth engaging slot, the upper teeth left engaging slot 28, exists between the upper teeth left plate and the main plate. Similarly, the lower teeth left engaging slot 35, the lower teeth right engaging slot 40, and the upper teeth right engaging slot 41 exist between the lower teeth left plate and the main plate, the lower teeth right plate and the main plate, and the upper teeth right plate and the main plate, respectively. The upper teeth left plate and the upper teeth right plate are on the opposite edges of the main plate. The lower teeth plate and the lower teeth right plate are at about the middles of opposite edges of the main plate. The openings of the teeth engaging slots face the bottom bend. The thickness or a portion of the thickness of the door stopper plate around the teeth engaging slots (the upper teeth left engaging slot, the lower teeth left engaging slot, the upper teeth right engaging slot, and the lower teeth right engaging slot) are slightly smaller than the spaces between the keys of the teeth (the upper teeth and the lower teeth of the upper teeth plate and the lower teeth plate of the tension plate). The door stopper plate thus can engage with the tension plate at the teeth and the teeth engaging slots.

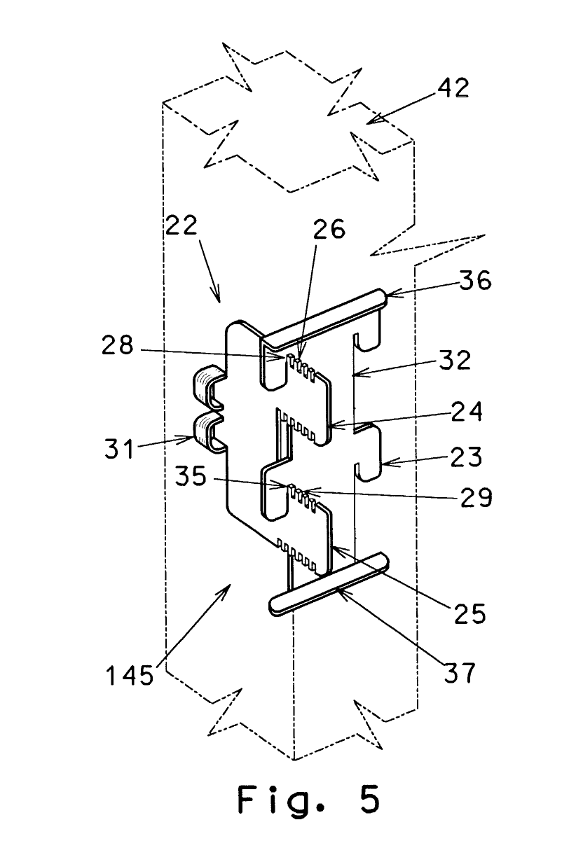

Referring to FIG. 5, when using the invented device 145 for the door 42 which opens inwardly with the bolt hole (not shown) on the left jamb, the user opens the door and puts the bolt hole head 31 into the bolt hole first. Then the user closes the door. The tension plate 22 will stay in the slot between the door and the left jamb. Then the user put the door stop plate 23 above the tension plate against the door with the main plate 32 facing the door. Then the user lines up the upper teeth left engaging slot 28 with a gap between the teeth of the upper teeth 26 of the upper teeth plate 24. The user also lines up the lower teeth left engaging slot 35 with a gap between the teeth of the upper teeth 29 of the lower teeth plate 25. Then the user lowers and pushes the door stopper plate towards the tension plate and let the two plates engage together by the teeth and the engaging slots. With the bolt hole head in the bolt hole and the engaged tension plate and the door stopper plate forming a rigid structure, the door can be locked in closed position. The top bend plate 36 and the bottom bend plate 37 increase the rigidity of the door stopper plate and provide objects to handle the door stopper plate

To unlock the door, the user lifts up the door stopper plate to disengage the tension plate and the door stopper plate Then the user removes the door stopper plate. The user then can open the door. The user then removes the device from the door jamb and the door can be used as it is intended to.

The uses of this device for the door which opens inwardly with the bolt hole on the right jamb are similar to those described in the last two paragraphs. The only difference is that the users will have to engage the tension plate and the door stopper plate with helps of the upper teeth right engaging slot and the lower teeth right engaging slot.

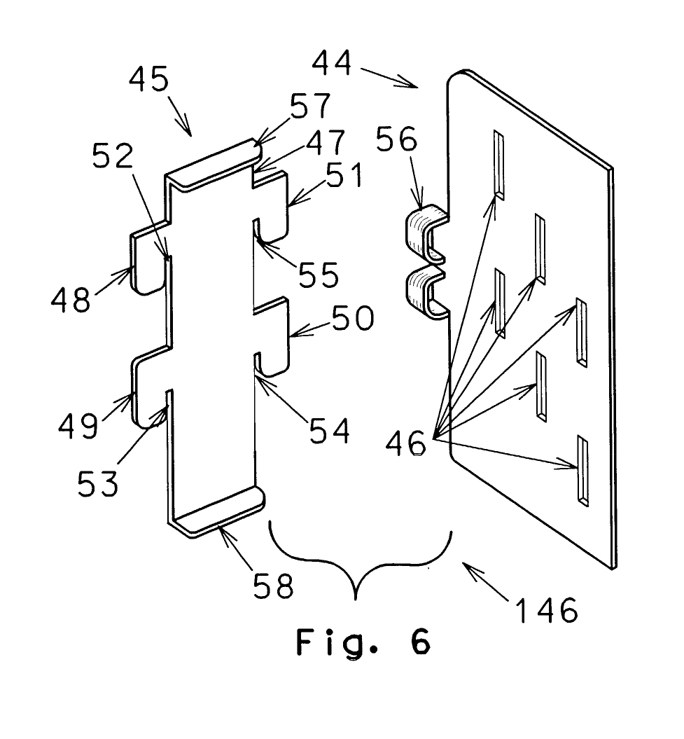

Referring to FIG. 6, the third sub-variation of the first variation of the invented portable latch 146 consists of a tension plate 44 and a door stopper plate 45.

The tension plate is a plate with a bolt hole head 56 on one edge and many columns of door stopper plate insert slots 46 The bolt hole head is the same as those bolt hole heads of those sub-variations described previously. The door stopper plate insert slots are staggered columns of slots with two slots in one column. The tension plate is thin enough to be able to be put in the slot between the door jamb and the door The length of the tension plate is more than the thickness of a door.

The door stopper plate is a plate which consists of a main plate 47, a top bend plate 57, a bottom bend plate 58, a left upper insertion plate 48, a left lower insertion plate 49, a right upper insertion plate 51, and a right lower insertion plate 50. The top bend plate and the bottom bend plate are on opposite edges of the main plate The top bend plate and the bottom bend plate each bends to the same side of the main plate. The longitudinal ends of the top bend plate and the bottom bend plate do not project beyond the edges of the main plate.

The left upper insertion plate, the left lower insertion plate, the right upper insertion plate, and the right lower insertion plate are short plates. A teeth engaging slot, the left upper engaging slot 52, exists between the left upper insertion plate and the main plate. Similarly, the left lower engaging slot 53, the right lower engaging slot 54, and the right upper engaging slot 55 exist between the left lower insertion plate and the main plate, the right lower insertion plate and the main plate, and the right upper insertion plate and the main plate, respectively. The left upper insertion plate and the right upper insertion plate are on the opposite edges of the main plate. The left lower insertion plate and the right lower insertion plate are at about the middles of opposite edges of the main plate. The openings of the teeth engaging slots face the bottom bend. The thickness of the plates of the door stop plates are slightly smaller than the widths of the door stopper plate insert slots. The spaces between the upper and the lower insertion plates (the left upper insertion plate and the left lower insertion plate, or, the right lower insertion plate and the right upper insertion plate) are the same as the space between the door stopper plate insert slots of each column of the slots. The upper and the lower insertion plates thus can be inserted into the door stopper plate insert slots to engage the door stopper plate and the tension plate

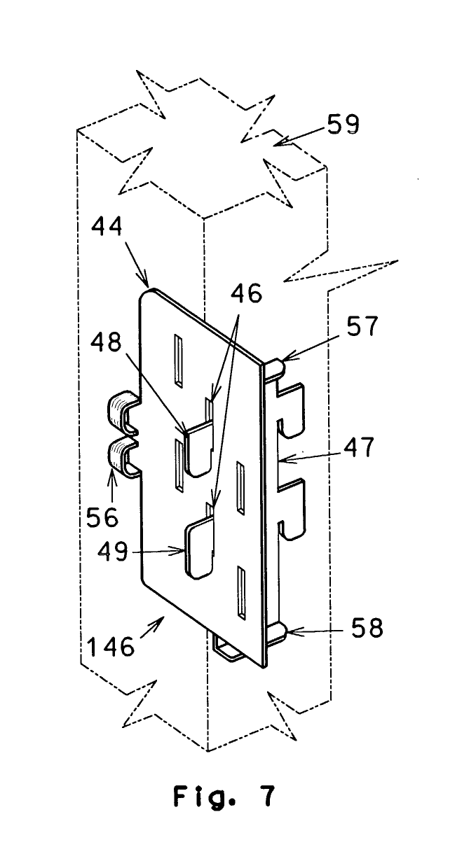

Referring to FIG. 7, when using the invented device 146 for the door 59 which opens inwardly with the bolt hole (not shown) on the left jamb, the user opens the door and puts the bolt hole head 56 into the bolt hole first. Then the user closes the door. The tension plate 44 will stay in the slot between the door and the left jamb Then the user put the door stop plate on the door side of the tension plate against the door with the main plate 47 touching the door. Then the user lines up the left upper insertion plate 48 and the left bottom insertion plate 49 with a column of the door stopper plate insert slots 46 Then the user pushes the left upper insertion plate and the left lower insertion plate into the door stopper plate insert slots until the left upper engaging slot and the left lower engaging slot are in the door stopper plate insert slots. Then the user slides downwards the door stopper plate to engage the door stopper plate with the tension plate. With the bolt hole head in the bolt hole and the engaged tension plate and the door stopper plate forming a rigid structure, the door can be locked in closed position The top bend plate 57 and the bottom bend plate 58 increase the rigidity of the door stopper plate and provide objects to handle the door stopper plate.

To unlock the door, the user lifts up the door stopper plate to disengage the tension plate and the door stopper plate. Then the user slides the door stopper plate out of the tension plate and removes the door stopper plate. The user then opens the door. The user then removes the device from the doorjamb and the door can be used as it is intended to.

The uses of the device for a door which opens inwardly with the bolt hole on the right jamb are similar to those described in the last two paragraphs The only difference is that the users will have to engage the tension plate and the door stopper plate with the right upper insertion plate, the right upper engaging slot, the right lower insertion plate, and the right lower engaging slot, instead.

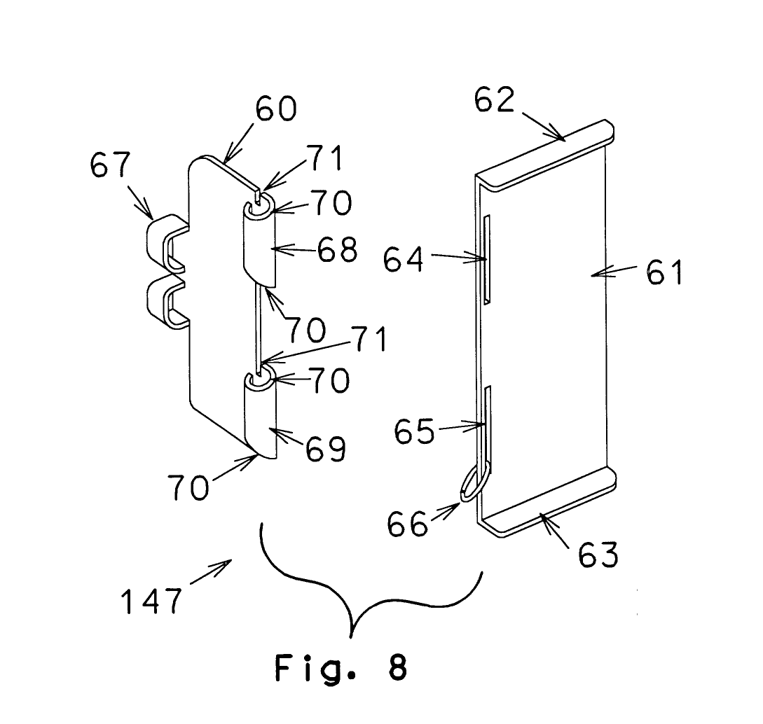

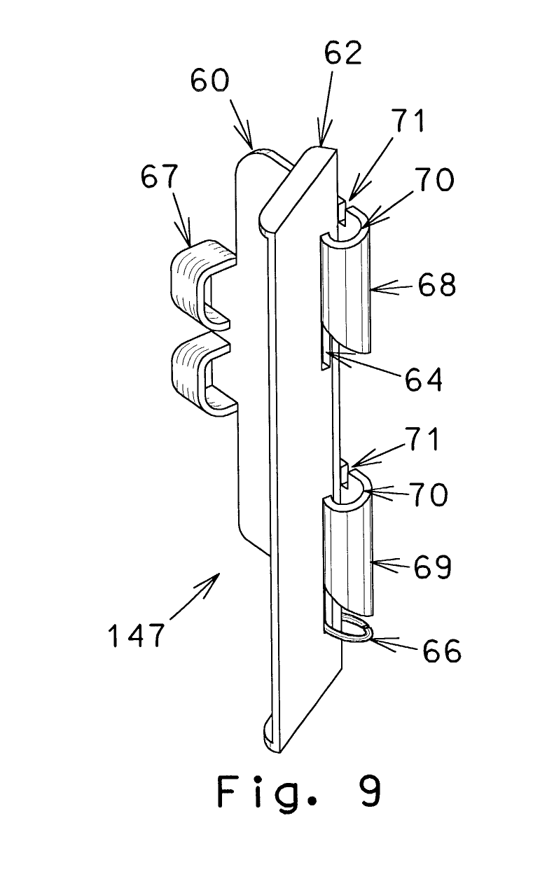

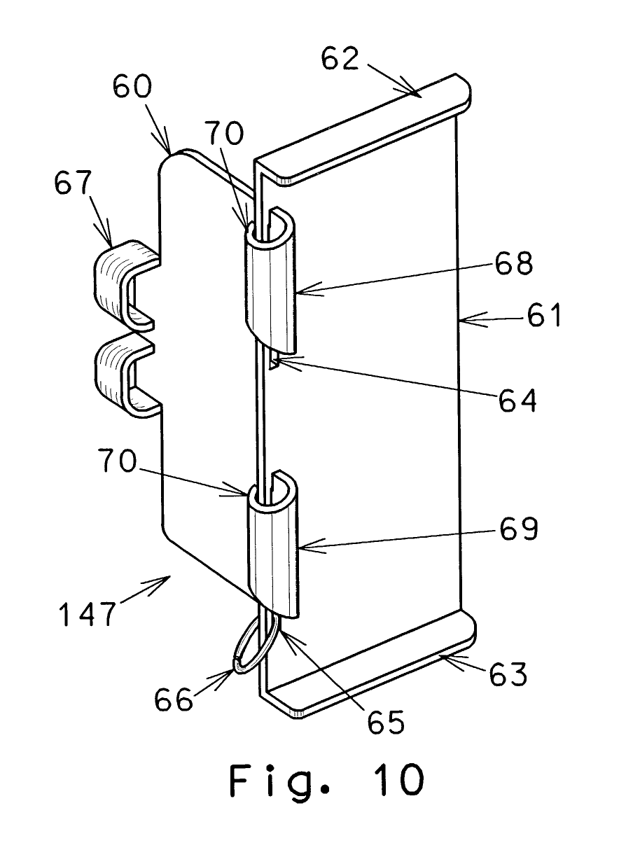

Referring to FIGS. 8, 9, and 10, the fourth sub-variation of the first variation of the invented portable latch 147 consists of a tension plate 60 and a door stopper plate 61.

The tension plate is a plate with a bolt hole head 67 on one edge and two hinge rings, the upper hinge ring 68 and the lower hinge ring 69, on the other edge. On each sides of each hinge rings there is a door stopper plate notch 71 which is a slot on the tension plate. The width of a door stopper plate notch is slightly wider than the door stopper plate. The hinge rings are hoops formed by curving around extruding portions of the tension plate. The top and bottom rims of each of the hinge rings have an inclined rim 70. The bolt hole head is the same as those bolt hole heads of those sub-variations described previously The tension plate is thin enough to be able to be put in the slot between the doorjamb and the door. The length of the tension plate is about the thickness of a door.

The door stopper plate is a plate which has two hinge slots (the upper hinge slot 64 and the lower hinge slot 65), a top bend plate 62, a bottom bend plate 63, and a limit ring 66. The limit ring is a ring which can hook on either of the hinge slots. The hinge slots are long slots on one edge of the door stopper plate. The top bend plate and the bottom bend plate are plates and are on opposite edges of the main plate. The top bend plate and the bottom bend plate each bends to the same side of the main plate.

The door stopper plate is hinged onto the tension plate by its hinge rings. The hinge rings hook through the hinge slots of the door stopper plate. When being pushed, the door stopper plate can move along the inclined rims of the hinge rings by allowing the top rims of the hinge slots travelling along the inclined rims of the hinge rings When the door stopper plate travels beyond the tips of the inclined rims of the hinge rings, portions of the door stopper plate will drop into the door stopper plate notch. The door stopper plate and the tension plate then form a rigid structure with the two plates at a right angle to each other.

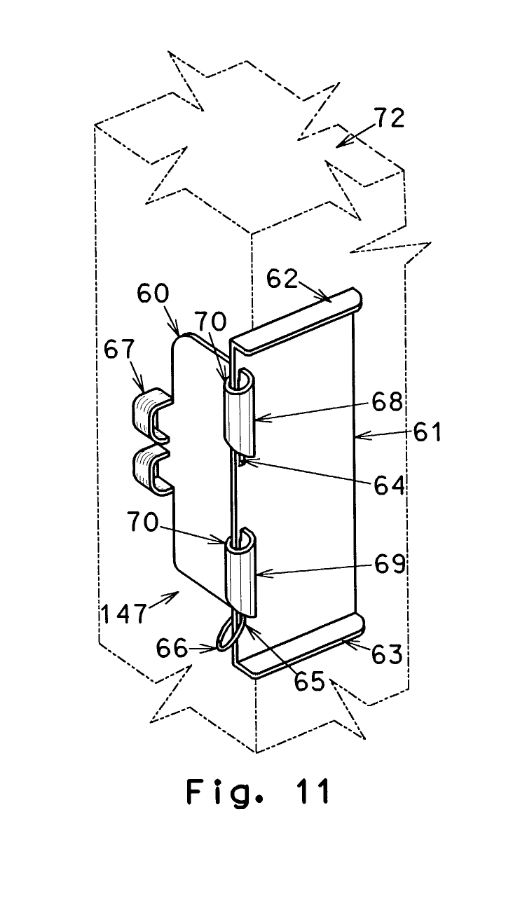

Referring to FIG. 11, when using the invented device 147 for the door 72 which opens inwardly with the bolt hole (not shown) on the left jamb, the user firstly ensure that the limit ring is hooked on either one of the hinge slots. The limit ring should be between the hinge ring and the end of the hinge ring slot which is closer to the bottom bend plate than to the top bend plate. The user then ensures that the door stopper plate is not in the door stopper plate notches. The limit ring will prevent the door stopper plate from being lifted up into the lower notches which are near the bottom sides of the upper hinge ring and the lower hinge ring. The user then opens the door and puts the bolt hole head 67 into the bolt hole Then the user closes the door. The tension plate 60 will stay in the slot between the door and the left jamb. Then the user pushes the door stopper plate along the inclined rims of the hinge rings until the door stopper plate travels beyond the tips of the inclined rims of the hinge rings. Then, portions of the door stopper plate will drop into the door stopper plate notches The door stopper plate and the tension plate will then form a rigid structure With the bolt hole head in the bolt hole and the engaged tension plate and the door stopper plate forming a rigid structure, the door can be locked in a closed position. The top bend plate 62 and the bottom bend plate 63 increase the rigidity of the door stopper plate and provide easy places to handle the door stopper plate.

To unlock the door, the user lifts up the door stopper plate and lets it slide down along the inclined rims. The user then can open the door. The user then removes the device from the door jamb and the door can be used as it is intended to be.

The uses of this device for the door which opens inwardly with the bolt hole on the right jamb are similar to those described in the last several paragraphs. The major difference for this use is that the limit ring will be placed on either one of the hinge slots between the hinge ring and the door stopper plate The limit ring will be at the end of the hinge slot which is closer to the top bend plate instead. The rests are the same.

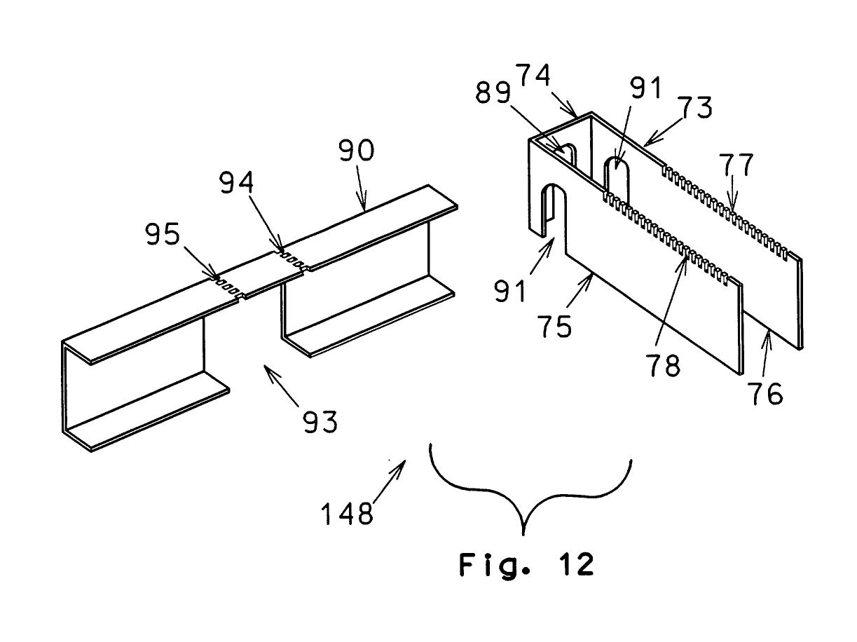

Referring to FIG. 12, the second variation of the invented portable latch 148 consists of a doorknob holder 73 and a door stopper 90.

The doorknob holder is a “U”-shaped object that consists of a back plate (or a web) 74, a left plate 75, and a right plate 76 The back plate is a plate that has an slot, the doorknob slot 89, on one edge. The back plate is slightly wider than a doorknob. The left plate and the right plate are plates that have teeth, the left teeth 78 and the right teeth 77, respectively, on one edge of each plate The teeth are keys that face upward while the opening of the doorknob slot faces downwards. The width (depth) of each of the plates is larger than the distance between the doorknob of a closed door and its door jamb. Each of the left plate and the right plate has an optional door handle slot 91 that is a slot with opening facing in opposite direction of the teeth. The door handle slot allows the doorknob holder to be able to rest on a door handle, when it exists The doorknob slot is wider than the narrowed-down portion of a doorknob but narrower than a doorknob handle or an enlarged portion of a doorknob. Therefore, a doorknob holder can be put onto a doorknob with the doorknob slot sitting on the narrowed-down portion of the doorknob. The same doorknob holder can not be pulled away from the doorknob longitudinally because the doorknob handle or the enlarged portion of a doorknob will stop the doorknob holder.

The door stopper 90 is an “U”-shaped channel with a doorknob holder slot 93 and two teeth engaging holes, the left teeth engaging holes 95 and the right teeth engaging holes 94, near its central portion. The doorknob holder slot 93 is a slot that is slightly wider than the doorknob holder 73. The teeth engaging holes are rows of holes that can engage with the left teeth 78 and the right teeth 77 of the doorknob holder.

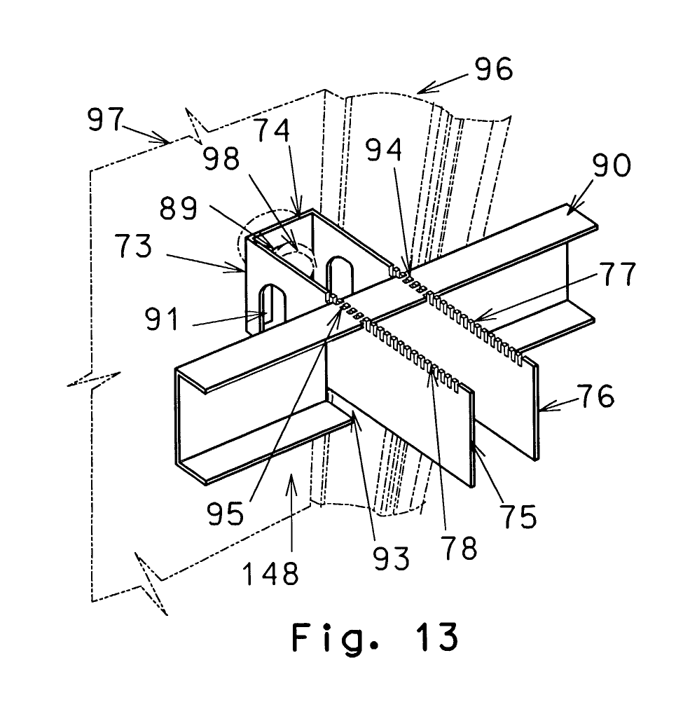

Referring to FIG. 13, when using the invented device 148 for a door 97 that opens outwardly, the user closes the door first. Then the user puts the doorknob holder 73 on the doorknob 98 by letting the doorknob slot 89 sit on the narrowed-down portion of the doorknob. Then the user puts the door stopper 90 on top of the doorknob holder with the doorknob holder penetrating the doorknob holder slot 93 and with the side of the door stopper against the door jamb. The user rocks the door stopper to let the teeth engaging holes 94 and 95 hunt for and engage with the teeth 77 and 78, respectively. Then the user pushes downwards the door stopper to let the teeth engaging holes firmly engage with the teeth. The door stopper and the doorknob holder then form a rigid structure. Because the enlarged portion of the doorknob acts against the back plate 74, the left plate 75, and the right plate 76, the rigid structure formed by the door stopper and the doorknob holder has limited freedom to move around. Because the depth of the right plate or the left plate is larger than the distance between the doorknob and the doorjamb, the right plate or the left plate will work against the door jamb to prevent the rigid structure from pivoting around the doorknob The rigid structure formed by the door stopper and the doorknob holder thus securely keeps the closed door locked. When the rigid structure is used on a door which doorknob has a handle, the handle will rest in a door handle slot 91. The handle will work against the side rims of the door handle slot and prevent the rigid structure to move around The rigid structure thus can lock a door which doorknob has a handle.

To unlock the door, the user lifts up the door stopper to disengage the teeth and the teeth engaging holes The user then removes the door stopper and the doorknob holder. The user then can open the door

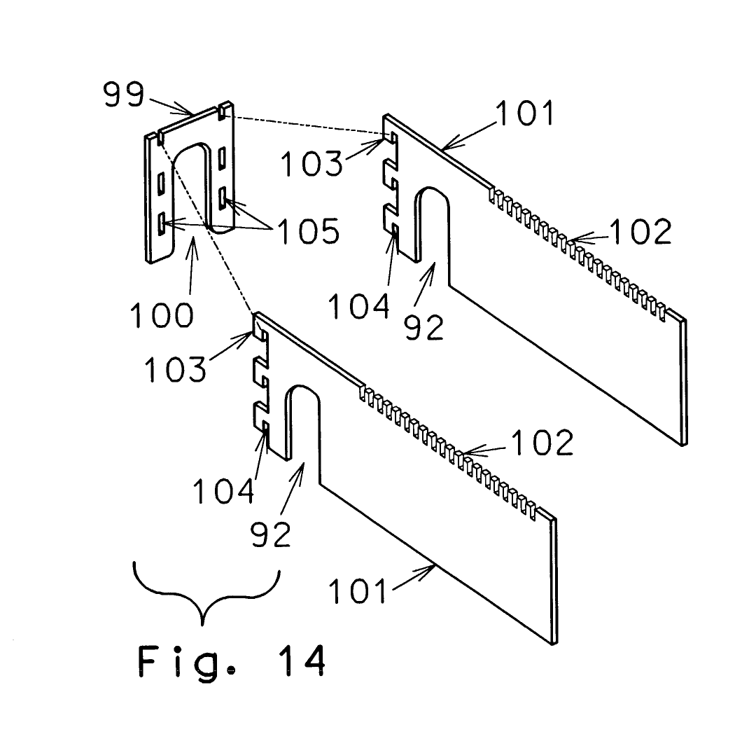

Referring to FIGS. 12 and 14, unlike the doorknob holder 73 which is a continuously rigid “U”-shaped object, the “U”-shaped doorknob holder can optionally be formed by two removable door stop plates 101, and a back plate 99. The back plate 99 has a doorknob slot 100 which is similar to the doorknob slot 89. The back plate 99 also has two columns of the back plate engaging slots 105 which are slots on the edges of the back plate. The door stop plate 101 has door stop plate teeth 102 which are teeth or keys on one edge of the plate. The door stop plate has an optional door handle slot 92 which is similar to the door handle slot 91. The door stop plate 101 has door stop plate keys 103 and door stop plate keying slots 104 along its edge. The door stop plate keys can penetrate the back plate engaging slots. The door stop plate keying slots can engage with the back plate. Two door stop plates can engage with a back plate to form a doorknob holder. The formed doorknob holder can be used in the same way as the doorknob holder 73.

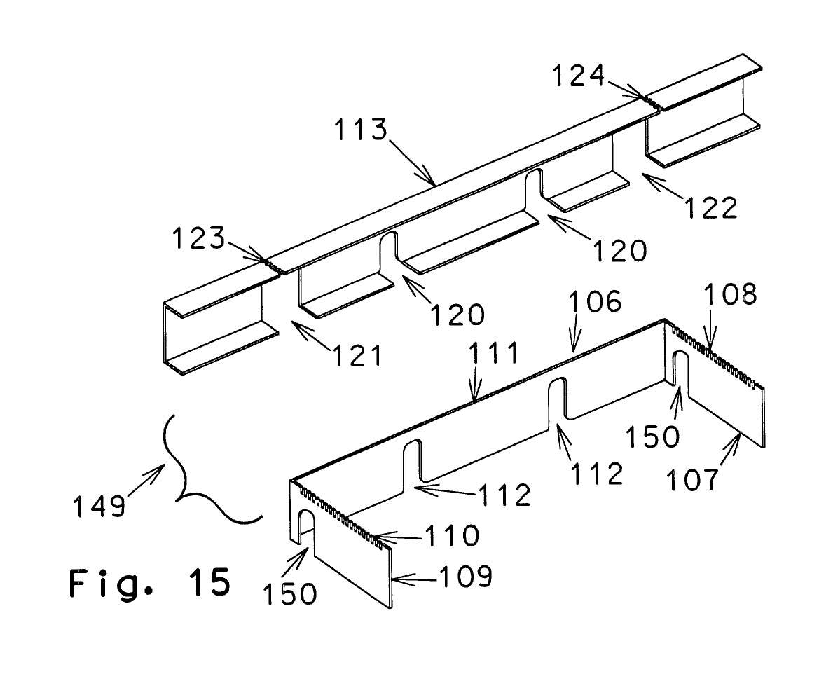

Referring to FIG. 15, the third variation of the invented portable latch 149 consists of a doorknob holder 106 and a door stopper 113.

The doorknob holder is a “U”-shaped object that consists of a back plate (or a web) 111, a left plate 109, and a right plate 107. The back plate is a plate that has two slots, the doorknob slots 112, on one edge The distance between the two slots is the same as the space between two doorknobs. The left plate and right plate are plates that have teeth, the left teeth 110 and the right teeth 108, respectively, on one edge of each plate. The teeth are keys that face upward while the openings of the doorknob slots face downwards. Each of the left plate and the right plate has an optional door handle slot 150 that is a slot with opening facing in opposite direction of the teeth. The door handle slots allow the doorknob holder to be able to rest on door handles. The doorknob slot is wider than the narrowed-down portion of a doorknob but narrower than a doorknob handle or an enlarged portion of a doorknob. Therefore, a doorknob holder can be put onto two doorknobs with the doorknob slot sitting on the narrowed-down portion of the doorknobs. But, the same doorknob holder can not be pulled away from the doorknob longitudinally of the doorknobs because the doorknob handles or the enlarged portions of the doorknobs will stop the doorknob holder.

The door stopper 113 is an “U”-shaped channel with two plate slots, the left plate slot 121 and the right plate slot 122, two doorknob slots 120, and two teeth engaging holes, the left teeth engaging holes 123 and the right teeth engaging holes 124. The plate slots allow the left plate or the right plate of the doorknob holder to penetrate. The doorknob slots are slots that are wider than the narrowed-down portion of a doorknob but narrower than a doorknob handle or an enlarged portion of a doorknob The teeth engaging holes are rows of holes that can engage with the left teeth 110 and the right teeth 108 of the doorknob holder. The openings of the plate slots and the doorknob slots face away from the teeth engaging holes

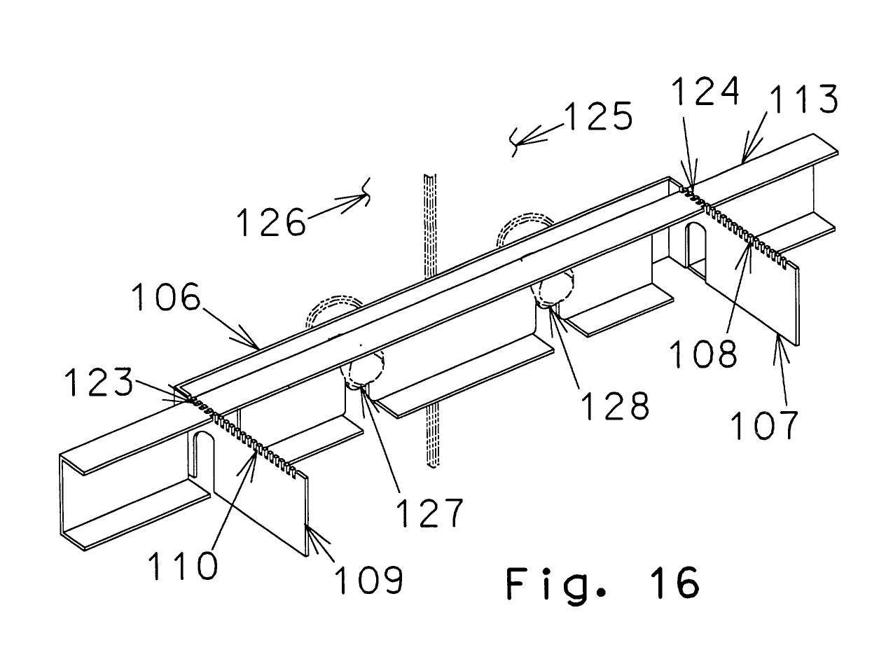

Referring to FIG. 16, when using the invented device 149 for two swing doors 125 and 126, the user closes the doors first. Then the user puts the doorknob holder 106 on the doorknobs 127 and 128 by letting the doorknob slots sit on the narrowed-down portion of the doorknobs. The back plate of the doorknob holder will be next to the doors. Then the user puts the door stopper 113 on top of the doorknob holder with the left plate 109 and the right plate 107 of the doorknob holder penetrating the left plate opening and the right plate opening of the door stopper, respectively The door stopper will sit on the narrowed-down portions of the doorknobs. The user rocks the door stopper to let the teeth engaging holes 123 and 124 hunt for and engage with the teeth 110 and 108, respectively. Then the user pushes downwards the door stopper to let the teeth engaging holes firmly engage with the teeth. The door stopper and the doorknob holder then form a rigid structure. Because the enlarged portion of the doorknob acts against the door stopper and the back plate of the doorknob holder against the doors, the rigid structure formed by the door stopper and the doorknob holder has limited freedom to move around. The rigid structure formed by the door stopper and the doorknob holder thus securely keeps the closed door locked When the rigid structure is used on a door which doorknob has a handle, the handle will work against the side rims of the door handle slot and prevent the rigid structure to move around. The rigid structure thus can keep locked a door which doorknob has a handle.

To unlock the doors, the user lifts up the door stopper to disengage the teeth and the teeth engaging holes. The user then removes the door stopper and the doorknob holder. The user then can open the doors.

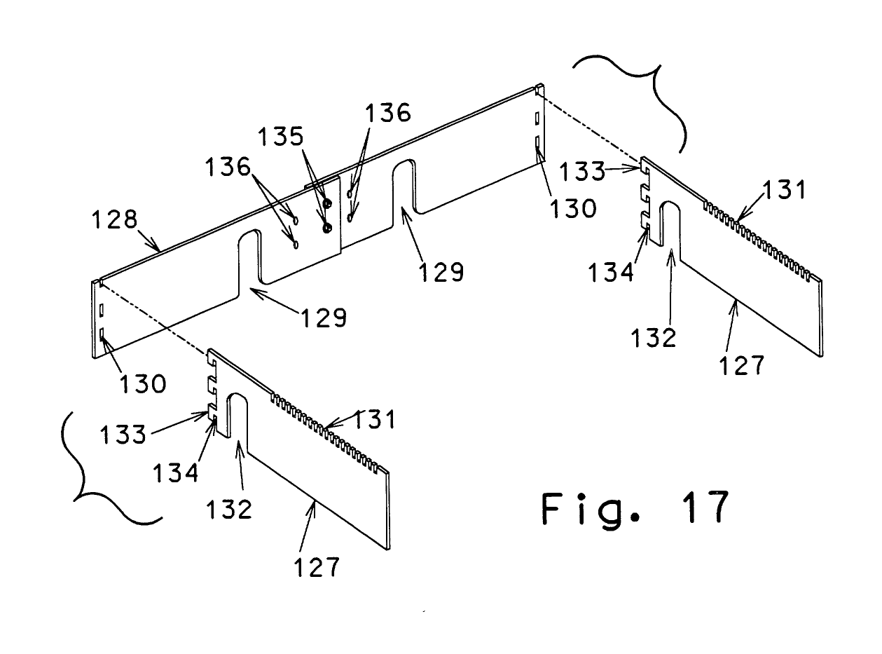

Referring to FIGS. 15 and 17, unlike the doorknob holder 106 which is a continuously rigid “U”-shaped object, the “U”-shaped doorknob holder can optionally be formed by two removable door stop plate 127, and a back plate 128 The back plate 128 has two doorknob slots 129 which are similar to the doorknob slots 112. The back plate 128 also has two columns of the back plate engaging slots 130 which are slots on the edges of the back plate. The door stop plate 127 has door stop plate teeth 131 which are teeth or keys on one edge of the plate. The door stop plate has an optional door handle slot 132 which is similar to the door handle slot 150 The door stop plate 127 has door stop plate keys 133 and door stop plate keying slots 134 along its edge. The door stop plate keys can penetrate the back plate engaging slots. The door stop plate keying slots can engage with the back plate Two door stop plates can engage with a back plate to form a doorknob holder. The formed doorknob holder can be used in the same way as the doorknob holder 106. The back plate 128 optional has length adjusting means such as bolts and nuts 135 and holes 136 which allow the length of the plate to be adjusted.

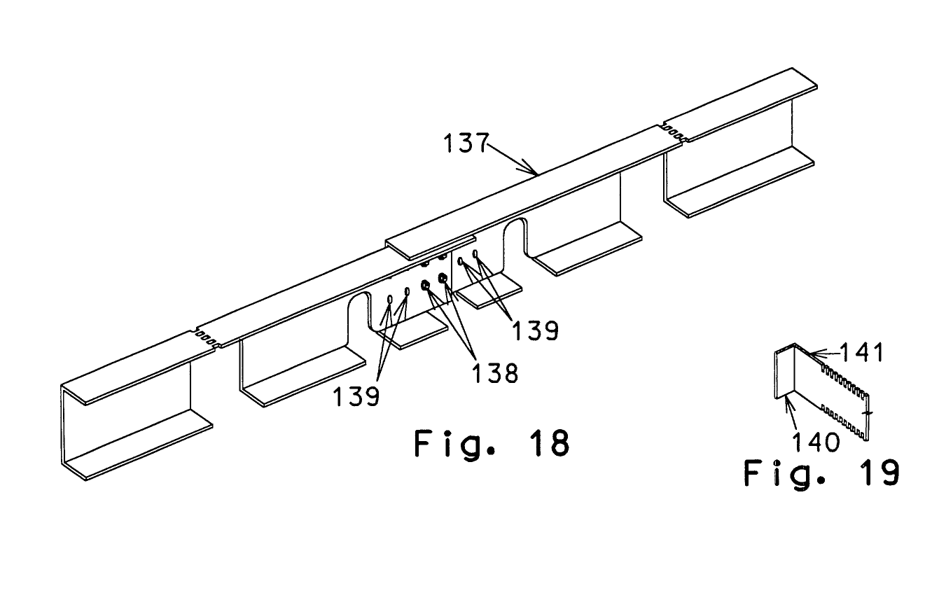

Referring to FIGS. 15 and 18, the door stopper 113 can have means to adjust its length. Thus, an adjustable door stopper 137 which function and components are the same as a door stopper 113 except that the adjustable door stopper has length adjusting means such as bolts and nuts 138 and holes 139 which allow the length of the plate to be adjusted.

Referring to FIGS. 1 and 19, in lieu of the bolt hole head 4, a bend 140 of a tension plate 141 can be used as the bolt hole head for a tension plate.

All of the top bend plates and the bottom bend plates discussed in this specifications are optional. In addition, the numbers of the teeth plates, the insert holes, the insertion plates, the hinges rings, the hinge slots, etc. can be more than what described in the previous paragraphs.

The foregoing is considered as illustrative only of the principles of the invention. Furthermore, since numerous modifications and changes will readily occur to those skilled in the art, it is not desired to limit the invention to the exact construction and operation shown and described, and accordingly all suitable modifications and equivalents, may be resorted to, falling within the scope of the invention as claimed.

I claim:

1. A portable latch consists of
a) a tension plate;
b) a travelling part;
c) said tension plate being generally an elongated plate with a bolt hole head on one end, a slide-off stopper near the other end, and a tooth in plural form on the other two edges;
d) said bolt hole head being a mean which locally increases the size of said end of said tension plate;
e) said bolt hole head being able to engage with a bolt hole of a doorjamb;
f) said slide-off stopper being a mean which can increase the size of said end of said tension plate;
g) said travelling part consisting of a left plate, a upper traveling teeth plate, a lower travelling teeth plate, a right plate, and a fastening mean in plural form;
h) said upper traveling teeth plate being an elongated plate with a fastening hole in plural form and with a tooth in plural form on one edge;
i) said lower traveling teeth plate being an elongated plate with a fastening hole in plural form and with a tooth in plural form on one edge;
j) said left plate being a plate with a fastening hole in plural form;
k) said right plate being a plate with a fastening hole in plural form and with a sharp bend;
l) said left plate and said right plate sandwiching said upper travelling teeth plate, said lower travelling teeth plate, and said tension plate with said upper travelling teeth plate, said tension plate and said lower travelling teeth plate being on one plane and with said tooth of said upper travelling teeth plate facing said tooth of said tension plate and with said tooth of said lower travelling teeth plate facing said tooth of said tension plate;
m) said fastening mean fastening together said left plate, said right plate, said upper travelling teeth plate and said lower travelling teeth plate though said fastening hole;
n) said tooth of said upper travelling teeth plate being able to engage and disengage with said tooth of said tension plate;
o) said tooth of said lower travelling teeth plate being able to engage and disengage with said tooth of said tension plate.

2. A portable latch of claim 1 wherein said travelling part has an engage limit which is an object that can be inserted between said tension plate and said upper travelling teeth plate.

3. A portable latch of claim 1 wherein said bolt hole head is made of a bent-over stripe of said tension plate.

4. A portable latch of claim 1 wherein said bolt hole head is made of a bent-over stripe in plural form of said tension plate

5. A portable latch of claim 1 wherein said slide-off stopper is an object extruding from said tension plate

6. A portable latch consists of
a) a tension plate;
b) a door stopper plate;
c) said tension plate being generally a plate with a bolt hole head on one edge and a teeth plate in plural form on the opposite edge;
d) said bolt hole head being a mean which locally increases the thickness of said tension plate;
e) said teeth plate being a plate with a tooth in plural form on opposite edges;
f) said door stopper plate being a plate which has an extruding plate in plural form on two opposite edges,
g) the number of said extruding plate along a edge of said door stopper plate being the same as the number of said teeth plate of said tension plate;
h) said extruding plate having a gap which is slightly wider than the thickness of said tension plate;
i) said tooth of said teeth plate of said tension plate being able to engage with said gap of said extruding plate of said door stopper plate.

7. A portable latch of claim 6 wherein said door stopper plate has a bend on a edge.

8. A portable latch of claim 6 wherein said bolt hole head is made of a bent-over stripe of said tension plate.

9. A portable latch of claim 6 wherein said bolt hole head is made of a bent-over stripe in plural form of said tension plate.

10. A portable latch consists of
a) a tension plate;
b) a door stopper plate;
c) said tension plate being generally a plate with a slot in plural form and with a bolt hole head on one edge;
d) said bolt hole head being a mean which locally increases the thickness of said tension plate;
e) said door stopper plate being a plate which has a extruding plate in plural form extruding on two opposite edges;
f) the number of said extruding plate along a edge of said door stopper being the same as the number of said slot of said tension plate in one column;
g) said extruding plate being able to penetrate said slot;
h) said extruding plate having a gap which is slightly wider than the thickness of said tension plate;
i) said tension plate around said slot being able to engage with said gap.

11. A portable latch of claim 10 wherein said door stopper plate has a bend on a edge.

12. A portable latch of claim 10 wherein said bolt hole head is made of a bent-over stripe of said tension plate.

13. A portable latch of claim 10 wherein said bolt hole head is made of a bent-over stripe in plural form of said tension plate.

14. A portable latch consists of
a) a tension plate;
b) a door stopper plate;
c) said tension plate being generally a plate with a hinge ring in plural form on one edge and a bolt hole head on the opposite edge;
d) said bolt hole head being a mean which locally increases the thickness of said tension plate;
e) said hinge ring being a thick ring with a slant rim on each end;
f) between said slant rim and said plate of said tension plate being a notch which is slightly wider than the thickness of said tension plate;
g) said door stopper plate being a plate with a slot in plural form near one edge,
h) the number of said slot on said door stopper plate being the same as the number of said hinge ring of said tension plate;
i) said hinge ring hooking on said door stopper plate through said slot of said door stopper plate;
j) said door stopper plate being able to engage with said tension plate at said notch.

15. A portable latch of claim 14 wherein said door stopper plate has a bend on a edge.

16. A portable latch of claim 14 wherein said bolt hole head is made of a bent-over stripe of said tension plate.

17. A portable latch of claim 14 wherein said bolt hole head is made of a bent-over stripe in plural form of said tension plate.

18. A portable latch consists of
a) a doorknob holder,
b) a door stopper;
c) said doorknob holder being generally a “U”-shaped object with sufficient depth and width;
d) the web of said doorknob holder having a slot which has an opening;
e) said slot of said doorknob holder being wide enough to allow a narrowed-down portion of a doorknob to pass through but not the doorknob itself;
f) a tooth in plural form being on one edge of each of the two limbs of said doorknob holder;
g) said tooth and said opening of said slot of said doorknob holder facing opposite directions;
h) said door stopper being an elongated member with a tooth engaging hole in plural form;
i) said tooth engaging hole being a hole which can engage with said tooth of said doorknob holder.

19. A portable latch of claim 18 wherein said door stopper has an open slot.

20. A portable latch of claim 18 wherein said door stopper has an open slot in plural form.

21. A portable latch of claim 18 wherein each of said two limbs of said doorknob holder has a slot which opening is on the edge that does not have said tooth

22. A portable latch of claim 18 wherein said web of said doorknob holder which has a slot in plural form along two edges and which each of said two limbs has a key in plural form that can engage with said slot of said doorknob to form said doorknob holder.

23. A portable latch of claim 18 wherein said web of said “U”-shaped object has a slot in plural form in lieu of a single said slot.

24. A portable latch of claim 18 wherein said web of said doorknob holder has means which allow the distance between said two limbs of said doorknob holder to be adjustable.

25. A portable latch of claim 24 wherein said means include a slot in plural form on said web and a bolt-nut-washer assembly in plural form.

26. A portable latch of claim 18 wherein said door stopper has means which allow the distance between said slot of said door stopper to be adjustable.

27. A portable latch of claim 26 wherein said means include a slot in plural form on said door stopper and a bolt-nut-washer assembly in plural form.

28. A portable latch of claim 14 wherein a ring-liked object can be hooked on said door stopper plate through said slot of said door stopper plate.
